(19) United States
(12) Patent Application Publication
(10) Pub. No.: US 2023/0228262 A1
(43) Pub. Date: Jul. 20, 2023

(54) Axial Piston Device

(71) Applicant: Kubota Corporation, Osaka-shi (JP)

(72) Inventor: Rei Okuma, Sakai-shi, Osaka (JP)

(21) Appl. No.: 17/928,749

(22) PCT Filed: May 27, 2021
(86) PCT No.: PCT/JP2021/020106

§ 371 Date: Nov. 30, 2022

(30) Foreign Application Priority Data
Jun. 29, 2020 (JP) 2020-111992

(51) Int. Cl. F04B 1/2035; F03C 1/06; F04B 1/2078

(52) U.S. Cl. CPC F04B 1/2035; F03C 1/06; F04B 1/2078

(57) ABSTRACT

An axial piston device includes a cylinder block 11 rotatable integrally with a rotary shaft and having a plurality of cylinder chambers in a region surrounding the rotary shaft; a plurality of pistons 12 each contained in a corresponding one of the plurality of cylinder chambers; and a support configured to position respective protruding ends of the plurality of pistons; the cylinder block 11 has a plurality of cylinder ports 17 each continuous with a corresponding one of the plurality of cylinder chambers, and the plurality of cylinder ports 17 each have a central point T corresponding to the center of gravity in a cross section of a flow path at the cylinder port 17 and are, as viewed along the axis X, adjacent to one another along an imaginary circle C around the axis.

### CROSS REFERENCE TO RELATED APPLICATION

This application is the United States national phase of International Application No. PCT/JP2021/020106 filed May 27, 2021, and claims priority to Japanese Patent Application No. 2020-111992 filed Jun. 29, 2020, the disclosures of which are hereby incorporated by reference in their entirety.

### BACKGROUND OF THE INVENTION

### Field of the Invention

The present invention relates to an axial piston device for use as, for example, a pump or motor for a hydraulic, continuously variable transmission device.

### Description of Related Art

Japanese Patent Application Publication, Tokukaihei, No. H5-195946 (Patent Literature 1) discloses, as an example, a hydrostatic, continuously variable transmission device including an axial plunger pump and an axial plunger motor. The pump includes a swash plate configured to be angled to control the amount of operating oil to be discharged. The motor receives operating oil from the pump for rotation.

The pump and motor disclosed in Patent Literature 1 share an identical basic configuration: They each include a cylinder block including a plurality of cylinders that contain respective plungers configured to extend and contract to suck and discharge operating oil through respective ports in the cylinder block.

Patent Literature 1
Japanese Patent Application Publication, Tokukaihei, No. H5-195946

For example, an axial plunger hydraulic pump includes, as described in Patent Literature 1, a cylinder block that has a plurality of cylinder chambers containing respective pistons (“plungers” in Patent Literature 1) and that has ports continuous with the respective cylinder chambers.

The hydraulic pump also includes a case that is adjacent to the ports and that has two flow paths (“ports for entry and exit of oil”) configured to become continuous with the ports and each having a shape of a segment of a circle around a rotary shaft (“input shaft”). A continuously variable transmission device including such a hydraulic pump is configured such that rotating the cylinder block integrally with the rotary shaft with the swash plate at a predetermined angle contracts the pistons to discharge high-pressure operating oil through the ports into one of the flow paths and extends the pistons to suck operating oil through the ports from the other flow path into the cylinders.

A hydraulic pump configured to suck and discharge operating oil through ports as above can, unfortunately, vibrate and cause noise due to a pressure change caused when the ports move between the two flow paths. In particular, rotating the rotary shaft at a constant speed causes vibration regularly with noise.

The above circumstances have led to a demand for an axial piston device including a cylinder block capable of rotating with reduced noise.

### SUMMARY OF THE INVENTION

An axial piston device according to the present invention includes: a cylinder block rotatable integrally with a rotary shaft and having a plurality of cylinder chambers in a region surrounding the rotary shaft; a plurality of pistons each slidably contained in a corresponding one of the plurality of cylinder chambers; and a support configured to position respective protruding ends of the plurality of pistons, wherein the cylinder block has a port face orthogonal to an axis of the rotary shaft, the cylinder block has a plurality of cylinder ports at the port face that are each continuous with a corresponding one of the plurality of cylinder chambers, the axial piston device further includes a pair of supply/discharge ports adjacent to the port face, each in a shape of a segment of a circle around the rotary shaft, and configured to supply and discharge a fluid through the plurality of cylinder ports in response to the rotation of the cylinder block, and the plurality of cylinder ports each have a central point corresponding to a center of gravity in a cross section of a flow path at the cylinder port and are, as viewed along the axis, adjacent to one another along an imaginary circle around the axis, the imaginary circle passing through the respective central points of the plurality of cylinder ports, such that each adjacent two of the plurality of cylinder ports are apart from each other by a first distance along the imaginary circle which first distance differs from a second distance along the imaginary circle by which second distance any other adjacent two of the plurality of cylinder ports are apart from each other.

With the above axial piston device configured as, for example, a hydraulic pump, rotating the cylinder block integrally with the rotary shaft with the support inclined in a predetermined orientation contracts the pistons to discharge high-pressure operating oil through the cylinder ports toward one of the supply/discharge ports and extends the pistons to suck operating oil through the cylinder ports from the other supply/discharge port into the cylinders. During this operation, moving each cylinder port from one of the supply/discharge ports to the other causes the cylinder block to vibrate due to a difference in the pressure of operating oil between the two supply/discharge ports. In view of that, the cylinder ports are apart from one another by circumferential distances different from one another; in other words, the cylinder ports are arranged such that the pitch angles between the adjacent ports are different from one another. This results in the cylinder block being vibrated irregularly due to the ports arranged as above. With this configuration, rotating the rotary shaft at a constant speed, for instance, does not let the cylinder block cause vibrational impacts regularly, thereby preventing large noise.

The above configuration thereby provides an axial piston device including a cylinder block capable of rotating with reduced noise.

The axial piston device may be further arranged such that two of the plurality of cylinder ports each have a phase angle of 0 degrees, whereas remaining ones of the plurality of cylinder ports have respective phase angles different from one another, each phase angle being formed between a first imaginary straight line and a second imaginary straight line, the first imaginary straight line connecting the central point of a corresponding one of the plurality of cylinder ports with a center of the imaginary circle, the second imaginary straight line connecting the center of the imaginary circle with a division point closest to the central point of the corresponding one of the plurality of cylinder ports, the division point being among a plurality of division points that divide the imaginary circle circumferentially into equal segments in a number of the plurality of cylinder ports.

With the above configuration, all the cylinder ports except for two thereof have respective central points each circumferentially displaced from its corresponding division point. This reduces regular vibrational impacts and noise caused by the cylinder block when the cylinder block is rotated at a constant speed. Further, two of the cylinder ports each coincide with its corresponding division point. This allows use of a jig for processing a conventional cylinder block with cylinder ports all circumferentially arranged at regular intervals. In addition, the above two cylinder ports, each of which coincides with its corresponding division point, can serve as a reference for processing pistons holes, thereby allowing piston holes to be processed easily.

The axial piston device may be further arranged such that one of the plurality of cylinder ports has a phase angle of 0 degrees, whereas remaining ones of the plurality of cylinder ports have respective phase angles different from one another, each phase angle being formed between a first imaginary straight line and a second imaginary straight line, the first imaginary straight line connecting the central point of a corresponding one of the plurality of cylinder ports with a center of the imaginary circle, the second imaginary straight line connecting the center of the imaginary circle with a division point closest to the central point of the corresponding one of the plurality of cylinder ports, the division point being among a plurality of division points that divide the imaginary circle circumferentially into equal segments in a number of the plurality of cylinder ports.

With the above configuration, all the cylinder ports except for one thereof have respective central points each circumferentially displaced from its corresponding division point. This prevents regular vibrational impacts and noise caused by the cylinder block when the cylinder block is rotated at a constant speed. Further, the above one cylinder port, which coincides with its corresponding division point, can serve as a reference for processing piston holes, thereby allowing piston holes to be processed easily.

The axial piston device may be further arranged such that the plurality of cylinder ports all have respective phase angles different from one another, each phase angle being formed between a first imaginary straight line and a second imaginary straight line, the first imaginary straight line connecting the central point of a corresponding one of the plurality of cylinder ports with a center of the imaginary circle, the second imaginary straight line connecting the center of the imaginary circle with a division point closest to the central point of the corresponding one of the plurality of cylinder ports, the division point being among a plurality of division points that divide the imaginary circle circumferentially into equal segments in a number of the plurality of cylinder ports.

The above configuration prevents regular vibrational impacts and noise caused by the cylinder block when the cylinder block is rotated at a constant speed.

The axial piston device may be further arranged such that as viewed along the axis, the plurality of pistons each have a center that coincides with the central point of a corresponding one of the cylinder ports.

The above axial piston device is configured such that as viewed along the axis, the pistons each have a center that coincides with the central point of its corresponding cylinder port. This allows the pistons to contract to linearly discharge a fluid through the cylinder ports and extend to linearly suck a fluid through the cylinder ports. This in turn reduces the flow path resistance and the energy loss.

### BRIEF DESCRIPTION OF DRAWINGS

FIG. 1 is a cross-sectional view of a continuously variable transmission device.

FIG. 2 is a diagram illustrating cylinder blocks and valve plates as developed to show their relationships.

FIG. 3 is a diagram illustrating how cylinder ports of a cylinder block are arranged.

FIG. 4 is a chart that shows the respective phase angles for cylinder ports.

FIG. 5 is a chart that shows pitch angles between cylinder ports.

### DESCRIPTION OF THE INVENTION

The description below deals with an embodiment of the present invention with reference to drawings.

### Basic Configuration

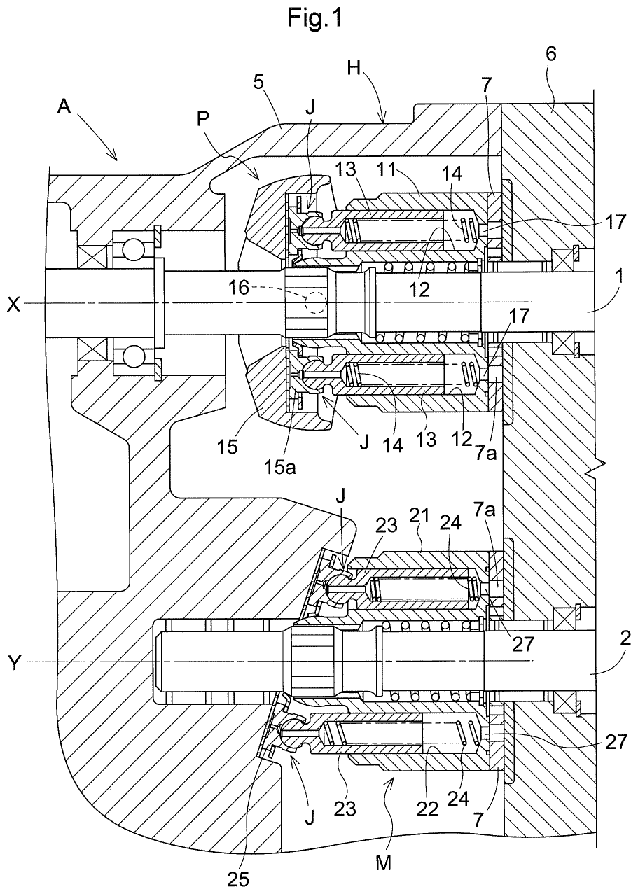

FIG. 1 illustrates a hydrostatic, continuously variable transmission device A including a housing H, a hydraulic pump P as an axial piston device in an upper portion of the internal space of the housing H, and a hydraulic motor M as an axial piston device under the hydraulic pump P.

The continuously variable transmission device A is intended for use as coupled to the transmission case (not shown in the drawings) of a vehicle such as a tractor. The left side of FIG. 1 corresponds to the front side of the vehicle, whereas the right side of FIG. 1 corresponds to the back side of the vehicle. The housing H includes a housing body 5 and a flow path block 6 coupled to each other to define the internal space.

The vehicle includes an engine (not shown in the drawings) forward of the continuously variable transmission device A (that is, to the left thereof in FIG. 1) and travel drivers such as an auxiliary transmission gear and a differential gear backward of the continuously variable transmission device A (that is, to the right thereof in FIG. 1). The continuously variable transmission device A includes a drive shaft 1 (which is an example of the “rotary shaft”) disposed at an upper portion of the housing H and configured to transmit the driving force of the engine, and also includes an output shaft 2 (which is an example of the “rotary shaft”) disposed under the drive shaft 1 and configured to transmit a varied driving force.

As illustrated in FIG. 1, the drive shaft 1 extends through the housing H in a front-back direction, and transmits its driving force to the hydraulic pump P, which is inside the housing H. The output shaft 2 protrudes backward from the housing H, and receives a varied driving force from the hydraulic motor M, which is inside the housing H.

Continuously Variable Transmission Device

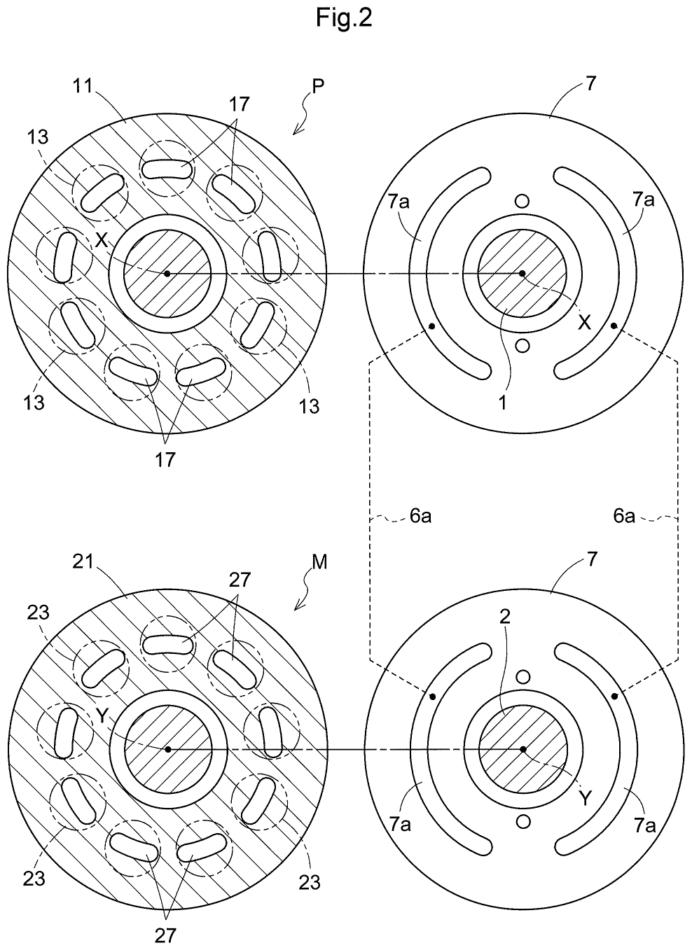

The continuously variable transmission device A is configured such that as illustrated in FIGS. 1 and 2, the flow path block 6 has a pair of drive flow paths 6a for supplying pressure oil from the hydraulic pump P to the hydraulic motor M and returning the operating oil from the hydraulic motor M to the hydraulic pump P. The hydraulic pump P is configured to steplessly adjust the amount of operating oil to be supplied. Adjusting the amount of operating oil to be supplied from the hydraulic pump P to the hydraulic motor M varies the travel speed of the vehicle steplessly.

The flow path block 6 has an inner face provided with a valve plate 7 adjacent to the hydraulic pump P and another valve plate 7 adjacent to the hydraulic motor M. Each valve plate 7 has a pair of supply/discharge ports 7a. The drive flow paths 6a in the flow path block 6 connect the supply/discharge ports 7a of one of the valve plates 7 with the supply/discharge ports 7a of the other to form flow paths for circulating operating oil.

The drive shaft 1 has a drive axis X, whereas the output shaft 2 has an output axis Y. The pair of supply/discharge ports 7a of each valve plate 7 are symmetrical to each other and each in the shape of a segment of a circle around the corresponding axis (that is, either the drive axis X or the output axis Y). The supply/discharge ports 7a of each valve plate 7 are each in the form of a hole in the valve plate 7, and are fixed to the inner face of the flow path block 6 to connect with the drive flow paths 6a.

Hydraulic Pump in Continuously Variable Transmission Device

The hydraulic pump P includes a first cylinder block 11, a plurality of first cylinder chambers 12, a plurality of first pistons 13, a plurality of first springs 14, a movable swash plate 15, and a trunnion shaft 16. The first cylinder block 11 is rotatable integrally with the drive shaft 1. The first cylinder chambers 12 are defined by the first cylinder block 11. The first pistons 13 are each contained in one of the first cylinder chambers 12. The first springs 14 are each contained in one of the first cylinder chambers 12 and configured to urge the corresponding first piston 13 in the direction in which the first piston 13 extends. The movable swash plate 15 (which is an example of the “support”) is interlocked with each first piston 13 with a spherical joint J between the movable swash plate 15 and the protruding end of the first piston 13. The trunnion shaft 16 couples the movable swash plate 15 to the housing H in such a manner that the movable swash plate 15 is swingable. The first springs 14 are optional.

The first cylinder chambers 12 are each in a region surrounding the drive shaft 1, and are parallel to the drive shaft 1. The first cylinder chambers 12 each contain its corresponding first piston 13 in such a manner that the first piston 13 is capable of reciprocating in a direction along the drive axis X of the drive shaft 1. The first cylinder block 11 has a port face facing its corresponding valve plate 7 and having a plurality of first cylinder ports 17 each continuous with one of the first cylinder chambers 12.

The movable swash plate 15 includes an annular structure with a central space through which the drive shaft 1 extends and a cam face facing the first pistons 13. The movable swash plate 15 is provided with a slidable ring 15a rotatable about the center of the annular structure to slide on the annular structure while in contact with the cam face. The movable swash plate 15 is also provided with a plurality of spherical joints J each between the slidable ring 15a and the protruding end of its corresponding first piston 13.

The movable swash plate 15 is held by the housing H with use of the trunnion shaft 16 so as not to receive the force of rotation of the drive shaft 1. When rotation of the trunnion shaft 16 has moved the movable swash plate 15 to its neutral orientation, in which the cam face is orthogonal to the drive axis X, as illustrated in FIG. 1, rotation of the first cylinder block 11 will not extend or contract the first pistons 13. The first pistons 13 will thus not supply or discharge operating oil, so that the hydraulic motor M is not rotated, leaving the vehicle at rest.

When rotation of the trunnion shaft 16 has caused the cam face to be inclined relative to the drive axis X, rotation of the first cylinder block 11 will extend and contract the first pistons 13. The extension of a first piston 13 sucks operating oil into the corresponding first cylinder chamber 12 through the corresponding first cylinder port 17, whereas the contraction of the first piston 13 discharges the operating oil from the first cylinder chamber 12 through the first cylinder port 17 for the hydraulic motor M to rotate.

The hydraulic pump P is particularly configured such that the movable swash plate 15 is movable to different orientations including the neutral orientation mentioned above. Inclining the movable swash plate 15 from its neutral orientation to one side causes pressure oil to be supplied into one of the drive flow paths 6a for circulation of operating oil. This in turn causes the hydraulic pump P to rotate in the forward-travel direction. Inclining the movable swash plate 15 from its neutral orientation to the other side causes pressure oil to be supplied into the other drive flow path 6a for circulation of operating oil. This in turn causes the hydraulic pump P to rotate in the backward-travel direction.

The hydraulic pump P is, as described above, configured such that changing the orientation of the movable swash plate 15 relative to its neutral orientation allows the vehicle to switch between forward travel and backward travel. Orienting the movable swash plate 15 farther away from its neutral orientation causes the vehicle to travel faster. The hydraulic pump P thereby allows the vehicle to change its speed steplessly.

Hydraulic Motor in Continuously Variable Transmission Device

The hydraulic motor M includes a second cylinder block 21, a plurality of second cylinder chambers 22, a plurality of second pistons 23, a plurality of second springs 24, and a fixed support 25. The second cylinder block 21 is rotatable integrally with the output shaft 2. The second cylinder chambers 22 are defined by the second cylinder block 21. The second pistons 23 are each contained in one of the second cylinder chambers 22. The second springs 24 are each contained in one of the second cylinder chambers 22 and configured to urge the corresponding second piston 23 in the direction in which the second piston 23 extends. The fixed support 25 (which is an example of the “support”) is disposed on the housing body 5 and interlocked with each second piston 23 with a spherical joint J between the fixed support 25 and the protruding end of the second piston 23. The second springs 24 are optional.

The second cylinder chambers 22 are each in a region surrounding the output shaft 2, and are parallel to the output shaft 2. The second cylinder chambers 22 each contain its corresponding second piston 23 in such a manner that the second piston 23 is capable of reciprocating in a direction along the output axis Y of the output shaft 2. The second cylinder block 21 has a port face facing its corresponding valve plate 7 and having a plurality of second cylinder ports 27 each continuous with one of the second cylinder chambers 22.

The fixed support 25 has a cam face facing the second pistons 23. The fixed support 25 is provided with a slidable ring 25a rotatable about the center of an annular structure to slide on the annular structure while in contact with the cam face. The fixed support 25 is also provided with a plurality of spherical joints J each between the slidable ring 25a and the protruding end of its corresponding second piston 23. The fixed support 25 is integral with the housing body 5 of the housing H such that the cam face is inclined relative to the output axis Y.

With the hydraulic motor M configured as above, operating oil supplied from the hydraulic pump P through one of the drive flow paths 6a presses a second piston 23 to extend in the space in which the second piston 23 is extendable. Subsequent contraction of the second piston 23 in the space in which the second piston 23 is contractable causes the operating oil to be discharged into the other drive flow path 6a. Supplying and discharging operating oil as such drives the second cylinder block 21 to rotate.

Arrangement of Ports

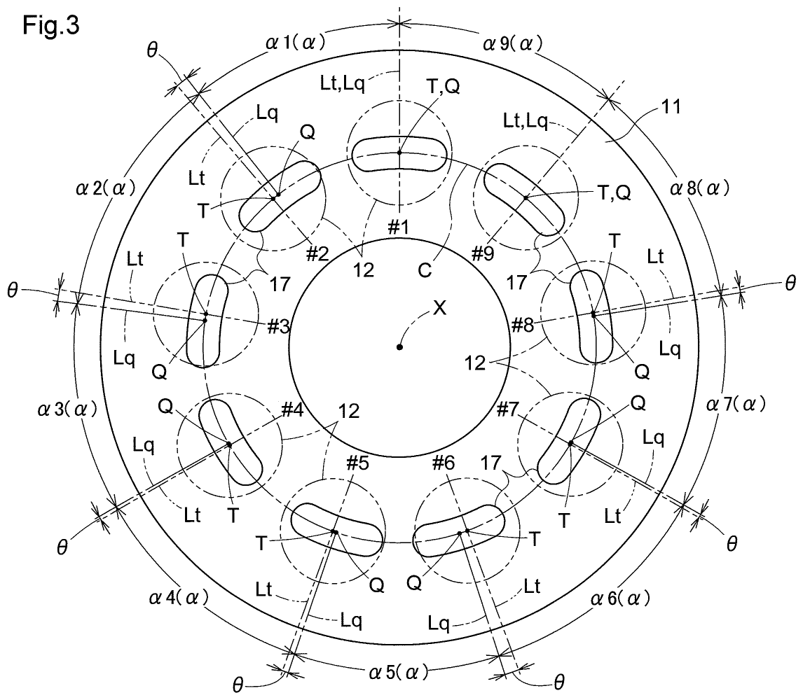

FIG. 3 illustrates how the first cylinder ports 17 are arranged across the port face of the first cylinder block 11 of the hydraulic pump P. The continuously variable transmission device A is configured such that the first cylinder ports 17 in the port face of the first cylinder block 11 are arranged circumferentially at irregular intervals as described later and that the second cylinder ports 27 in the port face of the second cylinder block 21 of the hydraulic motor M are arranged circumferentially at regular intervals.

The hydraulic pump P is configured such that the rotation of the drive shaft 1 causes the first pistons 13 to suck operating oil through one of the supply/discharge ports 7a and then discharge the operating oil through the other supply/discharge port 7a. Since the hydraulic pump P operates as such, that one of the supply/discharge ports 7a which serves to discharge operating oil is subject to a high pressure, whereas the other supply/discharge port 7a, which serves to suck operating oil, is subject to a low pressure.

With such a pressure difference between the two supply/discharge ports 7a, moving each first cylinder port 17 from one of the supply/discharge ports 7a to the other causes the first cylinder block 11 to vibrate due to the pressure change. In particular, rotating the drive shaft 1 at a constant speed (that is, at a constant rate of revolutions per unit time) would cause the first cylinder block 11 to vibrate regularly with noise. The first cylinder ports 17 are arranged to eliminate this disadvantage.

The hydraulic motor M is driven to rotate with one of the supply/discharge ports 7a in the corresponding valve plate 7 under a high pressure and the other supply/discharge port 7a under a low pressure. Specifically, operating oil supplied through the supply/discharge port 7a under a high pressure causes the second pistons 23 to extend and thereby drives the second cylinder block 21 to rotate. This rotation in turn causes the second pistons 23 to discharge the operating oil through the supply/discharge port 7a under a low pressure.

The present embodiment is configured such that the second cylinder ports 27 in the port face of the second cylinder block 21 of the hydraulic motor M are arranged circumferentially at regular intervals as mentioned above. However, the second cylinder block 21 can also vibrate during its rotation and cause noise. The hydraulic motor M may thus be modified such that the second cylinder ports 27 are arranged similarly to the first cylinder ports 17 of the hydraulic pump P.

As illustrated in FIGS. 2 and 3, the present embodiment includes nine first cylinder chambers 12, nine second cylinder chambers 22, nine first cylinder ports 17 continuous with the respective first cylinder chambers 12, and nine second cylinder ports 27 continuous with the respective second cylinder chambers 22. The above cylinder ports (that is, either the first cylinder ports 17 or the second cylinder ports 27) each have a circumferential length larger than its radial width as viewed along the corresponding axis (that is, either the drive axis X or the output axis Y). Each cylinder port has a central point T at the widthwise and lengthwise center. The central point T corresponds to the center of gravity in a cross section of the flow path at the cylinder port.

FIG. 3 shows C to indicate an imaginary circle around the drive axis X which imaginary circle passes through the central points T as viewed along the drive axis X, Q to indicate division points that divide the imaginary circle C circumferentially into nine (that is, the number of cylinder ports) equal segments, and Lq to indicate equal division lines as imaginary straight lines connecting the division points Q with the drive axis X. Each adjacent two of the equal division lines Lq form an angle of 40 degrees.

To prevent the above-mentioned vibration, some of the nine central points T are circumferentially displaced from the division points Q by different amounts, which are each hereinafter referred to as “phase angle θ”.

FIG. 3 shows #1 to #9 to indicate the nine equal division lines Lq for identification and Lt to indicate displacement lines as imaginary straight lines connecting the drive axis X with the central points T, some of which are each displaced from its corresponding equal division line Lq by a phase angle θ. FIG. 3 shows phase angles θ as exaggerated to facilitate understanding.

FIG. 3 shows α to indicate pitch angles each formed by adjacent two of the displacement lines Lt. For the present embodiment, FIG. 3 shows α1 to α9 to indicate respective pitch angles between the nine displacement lines Lt corresponding respectively to #1 to #9 for identification of the respective central points T of the cylinder ports, which central points T are positioned differently relative to the respective division points Q.

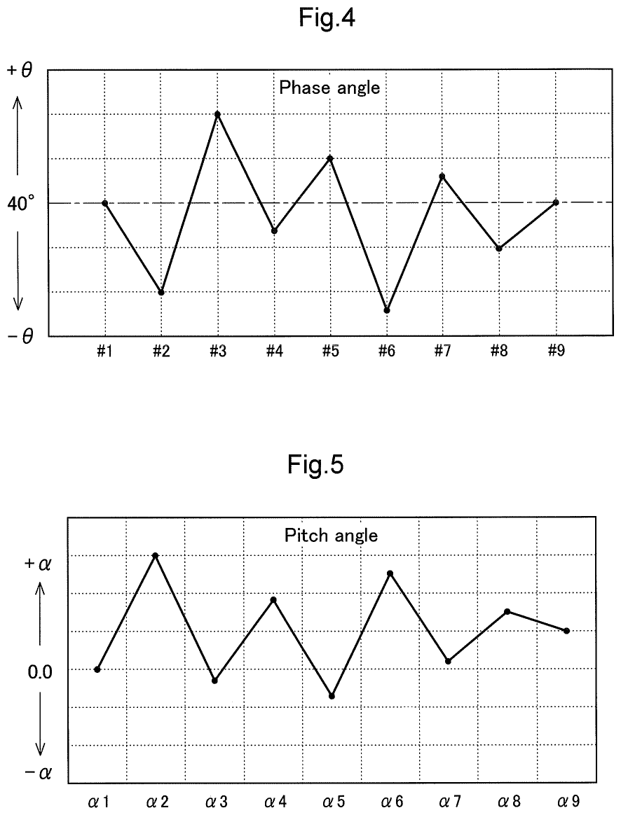

FIG. 4 is a chart that shows the respective phase angles θ for the nine central points T relative to their corresponding division points Q. FIG. 5 is a chart that shows the pitch angles α, which are each formed by adjacent two of the nine displacement lines Lt.

The chart of the phase angles θ in FIG. 4 has a horizontal axis with #1 to #9 corresponding respectively to the nine first cylinder ports 17 and a vertical axis with θ being a reference, the direction upward of 0 (positive direction) indicating a larger phase angle θ, and the direction downward of 0 (negative direction) indicating a smaller phase angle θ.

Assuming that the first cylinder block 11 is rotated clockwise as viewed along the drive axis X, the phase angle θ for a central point T is regarded as large when the central point T is displaced clockwise from its corresponding division point Q and as small when the central point T is displaced counterclockwise from its corresponding division point Q.

The chart of the pitch angles α in FIG. 5 has a horizontal axis with α1 to α9 indicative of the nine pitch angles described above and a vertical axis with 40° being a reference, the direction upward of 40° (positive direction) indicating a larger pitch angle α, and the direction downward of 40° (negative direction) indicating a smaller pitch angle α.

FIGS. 4 and 5 clearly show that the present embodiment is configured as follows: The two cylinder ports corresponding respectively to #1 and #9 have respective central points T each with a phase angle θ of 0 degrees. The other cylinder ports have respective central points T with respective phase angles θ different from one another. Each adjacent two of the other cylinder ports have respective central points T with respective phase angles θ one of which is in the positive direction and the other of which is in the negative direction. In other words, the first cylinder ports 17 are adjacent to one another along the imaginary circle C such that each adjacent two first cylinder ports 17 are apart from each other by a distance along the imaginary circle C which distance differs from the distance along the imaginary circle C by which distance any other adjacent two first cylinder ports 17 are apart from each other. Two of the first cylinder ports 17 have respective central points T each with a phase angle θ of 0 degrees, whereas the other first cylinder ports 17 have respective central points T with respective phase angles θ different from one another.

The hydraulic pump P is configured such that as viewed along the drive axis X, the nine cylinder ports have respective central points T that each coincide with the center of the corresponding first piston 13. This allows each piston to linearly suck operating oil into its corresponding cylinder chamber and linearly discharge operating oil out of the cylinder chamber, with the result of reduced flow path resistance and reduced energy loss.

### Operational Effects of Embodiment

The first cylinder block 11 has a port face with a plurality of first cylinder ports 17 arranged circumferentially at irregular intervals as described above. This prevents the hydraulic pump P from making noise even when the hydraulic pump P is rotated at a constant speed. This in turn allows production of a continuously variable transmission device A that operates quietly.

The hydraulic pump P has a plurality of (nine for the present embodiment) first cylinder ports 17 having respective central points T with respective phase angles θ different from one another relative to the respective division points Q. This prevents noise. Further, as viewed along the drive axis X, the first cylinder ports 17 have respective central points T that each coincide with the center of the corresponding first piston 13. This allows the flow path resistance and the energy loss by the hydraulic pump P to be reduced when each first piston 13 sucks and discharges operating oil through its corresponding first cylinder port 17.

The continuously variable transmission device A may be modified as mentioned above such that the hydraulic motor M has a plurality of (nine for the present embodiment) second cylinder ports 27 having respective central points T with respective phase angles θ different from one another relative to the respective division points Q. This will prevent noise. Further, as viewed along the output axis Y, the second cylinder ports 27 will have respective central points T that each coincide with the center of the corresponding second piston 23. This will allow the flow path resistance and the energy loss by the hydraulic motor M to be reduced when each second piston 23 sucks and discharges operating oil through its corresponding second cylinder port 27.

### Alternative Embodiments

The present invention may alternatively be arranged as below other than the embodiment described above (first embodiment). Any member below that is identical in function to a particular member described for the above embodiment has the same reference sign as that particular member.

(a) As already mentioned in relation to the first embodiment, the hydraulic motor M may include a second cylinder block 21 having a port face with a plurality of second cylinder ports 27 arranged circumferentially at irregular intervals similarly to the first cylinder ports 17 in the port face of the first cylinder block 11. Alternative embodiment (a) is thus configured such that both the first cylinder ports 17 and the second cylinder ports 27 are arranged at irregular intervals.

Alternative embodiment (a) is not necessarily configured such that the second cylinder ports 27 are displaced equally to the first cylinder ports 17. The second cylinder ports 27 may, for instance, have respective phase angles θ completely different from those for the first cylinder ports 17.

(b) The first embodiment is configured such that two of the nine cylinder ports (that is, either the first cylinder ports 17 or the second cylinder ports 27) each have a central point T not displaced from its corresponding division point Q. The embodiment may alternatively be configured such that only one of the nine cylinder ports has a central point T not displaced from its corresponding division point Q or that each of the nine cylinder ports has a central point T displaced from its corresponding division point Q.

A larger number of central points T displaced from their corresponding division points Q prevents vibration more effectively.

(c) The cylinder ports do not necessarily have respective central points T that each coincide with the center of the corresponding piston (that is, either the first pistons 13 or the second pistons 23). The first embodiment may, for instance, be altered such that while the central points T are displaced from the division points Q as described, the cylinder chambers are arranged circumferentially around the corresponding axis and equally spaced from one another. The cylinder chambers, in this case, do not necessarily coincide with the respective division points Q.

(d) The first embodiment may be altered to position the cylinder ports (that is, either the first cylinder ports 17 or the second cylinder ports 27) as desired by including a plate that has a plurality of cylinder ports each in the form of a hole at a preset position and that is attached to a cylinder block (that is, either the first cylinder block 11 or the second cylinder block 21). This allows the cylinder ports to be formed in a plate by press work or the like, thereby eliminating the need for an effort to increase the accuracy in forming the cylinder ports in a cylinder block.

Alternative embodiment (d) may be configured such that the cylinder ports have respective central points T that each coincide with the center of the corresponding cylinder chamber (that is, either the first cylinder chambers 12 or the second cylinder chambers 22) as described above or that the cylinder chambers are first arranged circumferentially around the corresponding axis and equally spaced from one another as in alternative embodiment (b), and a plate with the cylinder ports therein is then attached to the cylinder block for alignment of the cylinder ports.

### INDUSTRIAL APPLICABILITY

The present invention is applicable to axial piston devices.

### REFERENCE SIGNS LIST

1 Drive shaft (rotary shaft)
2 Output shaft (rotary shaft)
7a Supply/discharge port
11 First cylinder block (cylinder block)
12 First cylinder chamber (cylinder chamber)
13 First piston (piston)
Moveable swash plate (support)
17 First cylinder port (cylinder port)
21 Second cylinder block (cylinder block)
22 Second cylinder chamber (cylinder chamber)
23 Second piston (piston)
25 Fixed support portion (support)
27 Second cylinder port (cylinder port)
C Imaginary line
Q Division point
T Central point
X Drive axis (axis)
θ Phase angle
Lt Displacement line (imaginary straight line)
Lq Equal division line (imaginary straight line)

1. An axial piston device, comprising:
a cylinder block rotatable integrally with a rotary shaft and having a plurality of cylinder chambers in a region surrounding the rotary shaft;
a plurality of pistons each slidably contained in a corresponding one of the plurality of cylinder chambers; and
a support configured to position respective protruding ends of the plurality of pistons,
wherein:
the cylinder block has a port face orthogonal to an axis of the rotary shaft,
the cylinder block has a plurality of cylinder ports at the port face that are each continuous with a corresponding one of the plurality of cylinder chambers,
the axial piston device further comprises a pair of supply/discharge ports adjacent to the port face, each in a shape of a segment of a circle around the rotary shaft, and configured to supply and discharge a fluid through the plurality of cylinder ports in response to the rotation of the cylinder block, and
the plurality of cylinder ports each have a central point corresponding to a center of gravity in a cross section of a flow path at the cylinder port and are, as viewed along the axis, adjacent to one another along an imaginary circle around the axis, the imaginary circle passing through the respective central points of the plurality of cylinder ports, such that each adjacent two of the plurality of cylinder ports are apart from each other by a first distance along the imaginary circle which first distance differs from a second distance along the imaginary circle by which second distance any other adjacent two of the plurality of cylinder ports are apart from each other.

2. The axial piston device according to claim 1, wherein:
two of the plurality of cylinder ports each have a phase angle of 0 degrees, whereas remaining ones of the plurality of cylinder ports have respective phase angles different from one another,
each phase angle is formed between a first imaginary straight line and a second imaginary straight line,
the first imaginary straight line connects the central point of a corresponding one of the plurality of cylinder ports with a center of the imaginary circle,
the second imaginary straight line connects the center of the imaginary circle with a division point closest to the central point of the corresponding one of the plurality of cylinder ports,
the division point is among a plurality of division points that divide the imaginary circle circumferentially into equal segments in a number of the plurality of cylinder ports.

3. The axial piston device according to claim 1, wherein
one of the plurality of cylinder ports has a phase angle of 0 degrees, whereas remaining ones of the plurality of cylinder ports have respective phase angles different from one another,
each phase angle is formed between a first imaginary straight line and a second imaginary straight line,
the first imaginary straight line connects the central point of a corresponding one of the plurality of cylinder ports with a center of the imaginary circle,
the second imaginary straight line connects the center of the imaginary circle with a division point closest to the central point of the corresponding one of the plurality of cylinder ports,
the division point is among a plurality of division points that divide the imaginary circle circumferentially into equal segments in a number of the plurality of cylinder ports.

4. The axial piston device according to claim 1, wherein:
the plurality of cylinder ports all have respective phase angles different from one another,
each phase angle is formed between a first imaginary straight line and a second imaginary straight line,
the first imaginary straight connects the central point of a corresponding one of the plurality of cylinder ports with a center of the imaginary circle,
the second imaginary straight line connects the center of the imaginary circle with a division point closest to the central point of the corresponding one of the plurality of cylinder ports,
the division point is among a plurality of division points that divide the imaginary circle circumferentially into equal segments in a number of the plurality of cylinder ports.

5. The axial piston device according to claim 1, wherein:
as viewed along the axis, the plurality of pistons each have a center that coincides with the central point of a corresponding one of the cylinder ports.
